(19) United States
(12) Patent Application Publication
(10) Pub. No.: US 2016/0005226 A1
(43) Pub. Date: Jan. 7, 2016

(54) CLASSIFYING CONTIGUOUS OBJECTS FROM POLYGONAL MESHES WITH SPATIALLY GRID-LIKE TOPOLOGY

(71) Applicant: FOVIA, INC., Palo Alto, CA (US)

(72) Inventor: Kenneth BROWN, Palo Alto, CA (US)

(21) Appl. No.: 14/792,472

(22) Filed: Jul. 6, 2015

Related U.S. Application Data
(60) Provisional application No. 62/021,383, filed on Jul. 7, 2014.

(51) Int. Cl. G06T 17/20; G06T 3/20; G06T 5/00; G06T 11/20; G06T 15/20; G06T 17/30; G06T 15/02; G06T 11/40; G06T 3/00; G06T 15/08

(52) U.S. Cl. CPC G06T 17/20; G06T 17/205; G06T 3/0031; G06T 3/0043; G06T 3/20; G06T 5/006; G06T 15/08; G06T 15/20; G06T 17/30; G06T 15/02; G06T 11/40; G06T 11/20; G06T 2200/04; G06T 2200/28; G06T 2207/10004; G06T 2219/2012

(57) ABSTRACT

Methods and systems in computer enabled imaging for the classification of connected sets of polygons in polygonal models/objects with spatially grid-like topology are provided. In one example, for the classification of connected sets of polygons in polygonal models/objects with spatially grid-like topology such as those generated by threshold-based extraction routines from volumetric data by means of exploiting the nature of the source data to efficiently determine an optimal neighborhood of possibly connected polygon.

### CROSS-REFERENCE TO RELATED APPLICATION

This application claims priority to U.S. Provisional Patent Application Ser. No. 62/021,383, titled METHOD AND SYSTEM FOR CLASSIFYING CONTIGUOUS OBJECTS FROM POLYGONAL MESHES WITH SPATIALLY GRID-LIKE TOPOLOGY, and filed on Jul. 7, 2014, which is incorporated by reference herein its entirety for all purposes.

### FIELD

This generally relates to depiction of images of objects using computer enabled imaging, and especially to the polygonal representation of polygonal objects with spatially grid-like topology (such as those created from volumetric data).

### BACKGROUND

Visualization of volumetric objects that are represented by three dimensional scalar fields is one of the most complete, realistic, and accurate ways to represent internal and external structures of real 3-D (three dimensional) objects. As an example, Computer Tomography (CT) digitizes images of real 3-D objects (such as inside the human body) and represents them as a discrete 3-D scalar field representation. MRI (Magnetic Resonant Imaging) is another system to scan and depict internal structures of real 3-D objects (e.g., portions of the human body). As another example, the petroleum industry uses seismic imaging techniques to generate a 3-D image volume of a 3-D region in the earth. As in the human body, some important structures, such as geological faults or salt domes, may be embedded within the region and are not necessarily on the exterior surface of the region.

Direct volume rendering is a well-known computer graphics technique for visualizing the interior of a 3-D region represented by such a 3-D image volume on a 2-D image plane, e.g., as displayed on a computer monitor. Hence a typical 3-D dataset is a group of 2-D image “slices” of a real object generated by the CT or MRI machine or seismic imaging. Typically the scalar attribute or voxel (volume element) at any point within the image volume is associated with a plurality of classification properties, such as color—red, green, blue—and opacity, which can be defined by a set of lookup tables. During computer rendering, a plurality of “rays” is cast from the 2- D image plane into the volume and the rays are each attenuated or reflected by the volume. The amount of attenuated or reflected ray “energy” of each ray is indicative of the 3-D characteristics of the objects embedded within the image volume, e.g., their shapes and orientations, and further determines a pixel value on the 2-D image plane in accordance with the opacity and color mapping of the volume along the corresponding ray path. The pixel values associated with the plurality of ray origins on the 2-D image plane form an image that can be rendered by computer software on a computer monitor. Computer enabled volume rendering as described here may use conventional volume ray tracing, volume ray casting, splatting, shear warping, or texture mapping.

In the CT example discussed above, even though a doctor using MRI equipment and conventional methods can arbitrarily generate 2-D image slices (cuts) of, e.g., a human heart by intercepting the image volume in any direction, no single image slice is able to visualize the entire exterior surface of the heart. In contrast, a 2-D image generated through direct volume rendering of the CT image volume can easily display on an associated computer monitor the 3-D characteristics of the heart, which is very important in many types of cardiovascular disease diagnosis. Similarly in the field of oil exploration, direct volume rendering of 3-D seismic data has proved to be a powerful tool that can help petroleum engineers to determine more accurately the 3-D characteristics of geological structures embedded in a region that are potential oil reservoirs and to increase oil production significantly.

One of the most common and basic structures used to control volume rendering is the transfer function. Generally in mathematics, a transfer function is a representation of a linear time invariant dynamical system. In the context of computer graphics volume rendering, a transfer function defines the classification or translation of the original pixels of volumetric data (expressed as scalar values) to its representation on the associated computer monitor screen as a set of colors (or gray scale). Commonly used transfer functions convert the original (e.g., density) pixel data to a color—red, green, blue—and opacity classification. Hence each pixel as displayed has a color and opacity value defined from the original density or other data using a transfer function. The transfer function itself is mathematically, e.g., a simple ramp, a piecewise linear function or a lookup table. Note that the colors and opacity defined by the transfer function are arbitrary and not that of the actual depicted object. More generally, transfer functions in this context assign renderable (by volume rendering) optical properties to the numerical values (for each pixel) of the original dataset. The opacity function determines the contribution of each voxel to the final (rendered) image.

One of the most common needs of volume rendering applications is the extraction of traditional computer graphics polygonal objects from volumetric data. A polygon in computer graphics is a 2-D shape. Its position is defined by the XYZ coordinates of its vertices (corners). Volumetric data and polygonal object models representing the volumetric data are very different kinds of data in this field; volumetric data is a 3-D array of pixels while the well-known polygonal object model is a list of polygonal objects such as triangles or rectangles which are each represented by a grouping of correspondent XYZ vertices with assigned colors at each vertex.

Although direct volume rendering plays a key role in many important fields, 3D printing devices typically expect a polygonal representation of 3D objects. Thus, porting the visual information from volume rendering images to polygonal models is a practically valuable problem to address. However, traditional methods of extracting polygonal models from volumetric data typically produces models with a couple of undesirable traits. First, the triangle count of the extracted meshes can be significantly higher than is necessary to sufficiently represent the desired geometry (often outclassing 3D printer resolutions by an order of magnitude). Second, volumetric data created from real world objects can contain numerous extraneous objects. Some extraneous objects are inside the object and will not contribute to the object's visual appearance. Other extraneous objects are outside the object and will be treated as “noise” that does not contribute to the object's visual appearance.

Therefore, it would be desirable to efficiently classify which polygons in the polygonal model are connected to each other, and use that connection information to both eliminate unnecessary polygons and quickly discard extraneous internal and external extraneous objects.

### SUMMARY

The present disclosure relates generally to the field of computer enabled volume data rendering, and more particularly, to a method and system for classifying contiguous objects in polygonal models with specific topological characteristics. One embodiment includes a method and system for determining said contiguous objects from polygonal models generated from volumetric data. In one example, a method includes the acts of providing a polygonal model with a spatial grid-like topology, sorting polygons in the model into a three dimensional grid, determining a neighborhood of potentially connected polygons based on the topological consistency of the polygonal model, and sorting each polygon into its respective connected set. The exemplary method exploits the topological consistency of the polygon model to determine the neighborhood of potentially connected polygons, thereby reducing unnecessary polygons and discarding extraneous internal and external extraneous objects.

Examples may further include rendering the polygonal model based on less than all of the plurality of connected sets. Further, each polygon of the polygon model may include a consistent maximal width, height, and depth. The bounds of the polygonal model can be determined by examining the XYZ components of each vertex in the model and storing the minimum and maximum bounds for each component.

Each polygon in the model can be sorted into a list containing the polygons in the specified sub-grid of the polygonal model topology. The sorted polygons can further be iterated through, using information about potential neighbors to any given polygon, to determine polygons that are connected spatially, defined as two XYZ points in one polygon having the same correspondent XYZ values. In response to determining polygons are connected spatially, the polygons can be stored into a list representing that connected set, and a reference between two connected polygon edges can be stored.

In another example, an electronic device is provided, including one or more processors, memory, and one or more programs, wherein the one or more programs are stored in the memory and configured to be executed by the one or more processors, wherein the instructions are for receiving a polygonal model with spatially grid-like topology, sorting polygons in the model into a three dimensional grid, determining a neighborhood of potentially connected polygons based on a topological consistency of the polygonal model, and sorting each polygon into one of a plurality of connected sets. The devices may further includes instructions for causing a display of a polygon model based on less than all of the plurality of connected sets.

In another example an apparatus may include a first computer readable storage which stores a polygonal data-set representing a surface model in 3 dimensions, wherein the data-set includes a plurality of elements, providing a plurality of points for each element, wherein the points represent the corners connecting the primary edges of the polygon element. The apparatus further including a second computer readable storage which stores a list of references to polygonal elements for a given sub-grid in the three dimensional space and a third computer readable storage which stores a list of lists, wherein each outer list represents a connected set of polygons, and each inner list contains a list of references to polygons in that connected set, and each polygon reference includes a list of references to the immediate connected polygons to that polygon.

Additionally, systems, electronic devices, graphical user interfaces, and non-transitory computer readable storage medium (the storage medium including programs and instructions for carrying out one or more processes described) for classifying contiguous objects in polygonal models with specific topological characteristics are described.

### BRIEF DESCRIPTION OF THE DRAWINGS

The present application can be best understood by reference to the following description taken in conjunction with the accompanying drawing figures, in which like parts may be referred to by like numerals.

FIG. 1A illustrates an exemplary polygonal model generated from a synovial joint with a clipping plane applied so that internal extraneous objects are visible.

FIG. 1B illustrates an exemplary polygonal model generated from a synovial joint, processed according to one embodiment, to color extraneous sets differently for illustrative purposes.

FIG. 1C illustrates an exemplary polygonal model generated from a synovial joint, processed according to one embodiment, with all but the largest connected set of polygons removed.

FIG. 2A illustrates an exemplary polygonal model generated from a synovial joint at the full extraction resolution.

FIG. 2B illustrates an exemplary polygonal model generated from a synovial joint, processed by the method, and subsequently decimated using the resultant connection graph at a high removal threshold.

FIG. 2C illustrates an exemplary polygonal model generated from a synovial joint, processed by the method, and subsequently decimated using the resultant connection graph at a low removal threshold.

FIG. 3 illustrates an exemplary process for classifying connected sets in a polygon object.

FIG. 4 illustrates a block diagram of exemplary portions of the process and associated apparatus for classifying connected sets in a polygon object.

FIG. 5 illustrates an exemplary computing system that may be used to carry out various aspects of the present invention.

### DETAILED DESCRIPTION

The aforementioned features and advantages of the invention as well as additional features and advantages thereof will be more clearly understood hereinafter as a result of a detailed description of embodiments of the invention when taken in conjunction with the drawings. The description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the present technology. Thus, the disclosed technology is not intended to be limited to the examples described herein and shown, but is to be accorded the scope consistent with the claims.

In one aspect, a computer enabled method of classifying connected sets in a polygon object is provided. The exemplary method includes providing a polygonal model with a grid-like topology, sorting polygons in the model into a three dimensional grid, and determining a neighborhood of potentially connected polygons based on the topological consistency of the polygonal model. The polygons can then be sorted into respective connected sets, and certain sets removed from the model (e.g., smaller sets).

A user may provide a polygonal model where each polygon has a consistent maximal width, height, and depth. The bounds of the polygonal model can be determined by examining the XYZ components of each vertex in the model and storing the minimum and maximum bounds for each component.

After sorting the polygons, the sorted polygons can be iterated through, using knowledge about potential neighbors to any given polygon, to determine all polygons that are connected spatially, defined as two XYZ points in one polygon having the same correspondent XYZ values, and if connected, they can be stored into a list representing that connected set. A reference between two connected polygon edges can also be stored.

By using the method and system, the manual elimination of extraneous objects can be efficiently eliminated by automatically detecting the objects and setting a threshold for removal. Once extraneous objects are removed, the model is ready to be processed by decimation procedures in preparation for 3D printing. The practical application of this invention is not limited to this particular example, it rather illustrates one of cases where it may be applied, as determining topological characteristics of polygonal data is the starting point for many procedures and not just the ones offered in these examples.

Prior work has been done in determining the topological characteristics of polygonal data using a number of methods; however, none of the techniques both determine connection information and take advantage of the spatially grid-like topology of polygonal models such as those generated from volumetric data. For example, U.S. Pat. No. 6,323,863 describes a method for determining a skeletal topological graph, but does not provide exact connection information for all polygons. U.S. Pat. No. 7,805,463 spatially sorts geometry, but cannot benefit from constant time lookup and sorting because input polygons are not constrained to a specific grid step like data suitable for the present method and system. U.S. Pat. No. 7,805,463 exhibits both the lack of exact connection information and cannot benefit from the constant time approach. In the polygon decimation field, connection information is certainly necessary, but again they cannot benefit from the unique nature of the input data used by the present method and system. U.S. Pat. Nos. 6,954,203 and 6,891,535 are examples of decimation routines that use tree-like data structures to sort geometry spatially, providing logarithmic time complexity for lookup compared to the constant time complexity of the present method and system. All of the above references are hereby incorporated by reference as if fully set forth herein.

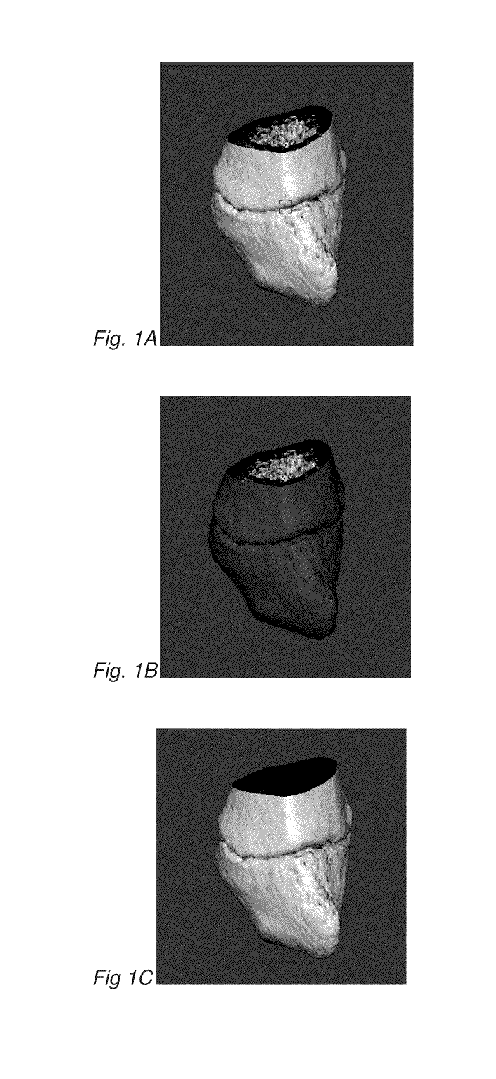

FIGS. 1A-1C illustrates a polygonal model generated from a synovial joint according to one example to illustrate features of the present invention. In particular, FIG. 1 illustrates an exemplary polygonal model generated from a synovial joint with a clipping plane applied so that internal extraneous objects are visible. As described above, for 3D printing applications, internal objects are not desired, and so internal objects can therefore be removed.

FIG. 1B illustrates the polygonal model generated from the synovial joint, processed to darken the desired sets of polygons and brighten the undesirable sets of polygons for illustrative purposes. For example, extracting the shell of a bone and printing it is a common use case for 3D printing in dental workflows. Because bone is generally hollow and spongy in its center, it is extremely common that such exports will have many extraneous objects (as seen in FIG. 1A as well) that are ordinarily cleaned out manually.

FIG. 1C illustrates an exemplary polygonal model generated from a synovial joint, processed according to one embodiment, with all but the largest connected set removed. This provides a polygonal model of the outer surface, with the inner objects removed, which may be desirable for 3D printing.

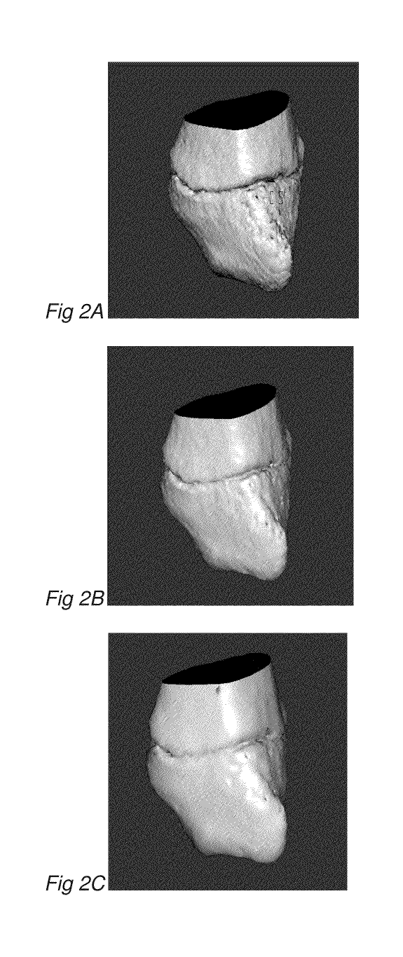

Further, various reduction process, e.g., decimation and removal of relatively smaller connected sets of polygons, can be performed on the polygon model. FIG. 2A illustrates an exemplary polygonal model generated from a synovial joint at the full extraction resolution. In this particular example, the number of polygons in the mesh numbers 96,263. FIG. 2B illustrates an exemplary polygonal model generated from the synovial joint, processed by the exemplary process described herein, and subsequently decimated (e.g., reducing the number of polygons in the mesh) using the resultant connection graph at a high removal threshold to reduce the number of polygons (in this particular example from 96,263 to 57,886). As illustrated, the surface structure of the bone in FIG. 2B is smoother and more uniform than the surface in FIG. 2A. FIG. 2C illustrates an exemplary polygonal model generated from the synovial joint, processed by the exemplary process, and subsequently decimated using the resultant connection graph at a low removal threshold to reduce the number of polygons to a greater degree than in FIG. 2B (in this particular example, from 96,263 to 19,057). As illustrated, the structure in this figure is smoother still than FIG. 2B, and more suitable for 3D printing or the like relative to FIGS. 2A and 2B.

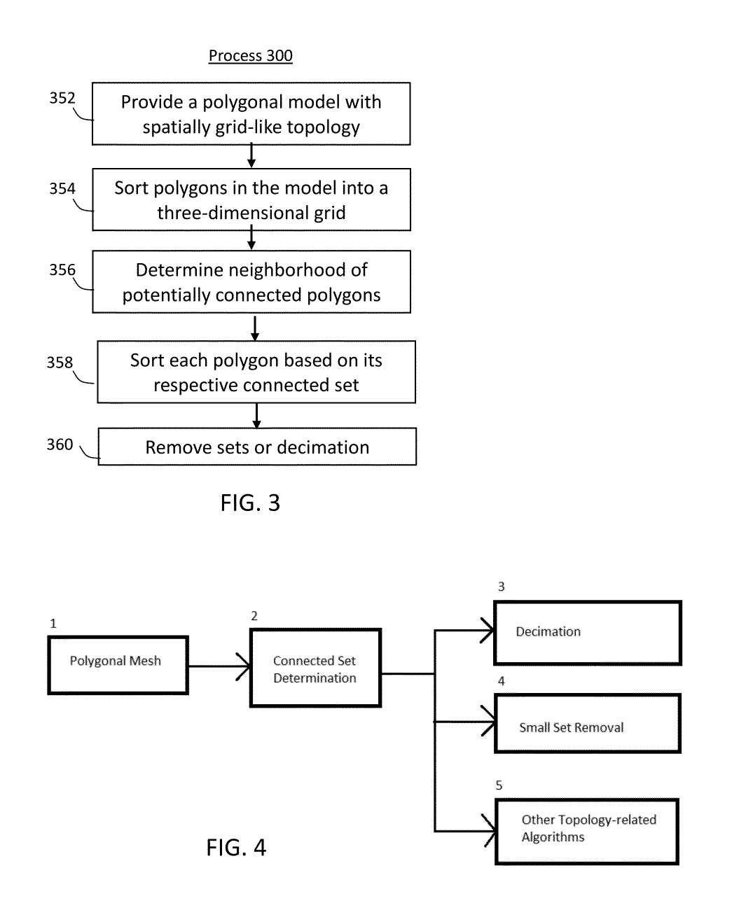

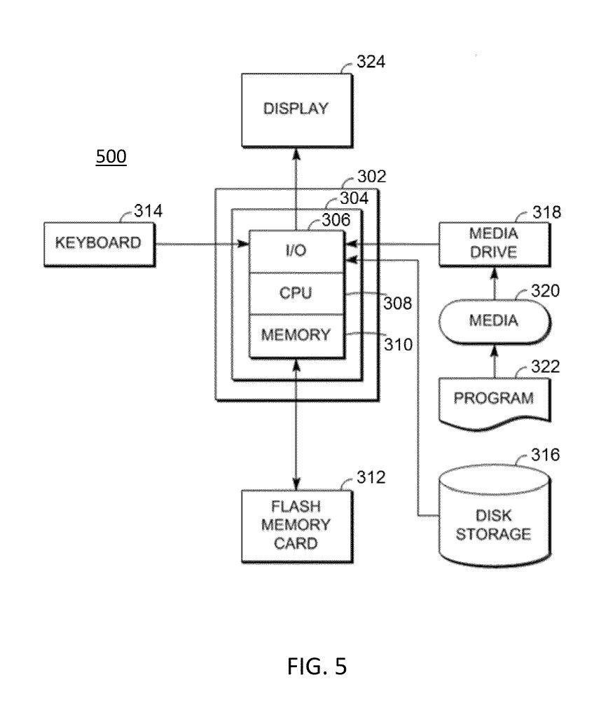

FIG. 3 illustrates an exemplary process 300 for classifying connected sets in a polygon object and FIG. 4 illustrates in a block diagram exemplary portions of both the process and associated apparatus. In one example, process 300 begins by providing a polygonal model/mesh with spatially grid-like topology. The polygonal model may be input by a user as a polygonal mesh 1 at step 352. It should be understood, that the source of the mesh could also be the output of a marching cube algorithm or other process for producing a polygonal object.

In one implementation, the present method and apparatus to determine the connected sets in a polygonal object is contained, at least partially, in computer software (code or a program) to be executed on a programmed computer or computing device. This code may be a separate application program and/or embedded in the polygonal model representation. The input data-set (e.g., the original polygonal mesh) may be provided live (in real time from a volume rendering application that extracts this type of mesh) or from storage, so the software may be resident in a standalone computer or in the computing portions of e.g., a CT or MRI machine or other platform. The computer software itself (coding of which would be routine in light of this disclosure) may be encoded in any suitable program language and stored on a computer readable medium in source code or compiled form. The output connection information itself is typically also stored in a computer readable medium (memory) in the computer.

The exemplary process and system first computes a three dimensional grid (e.g., a regular 3D-net and associated structure that presents polygons of a mesh by look-up table) that defines a lattice fully encompassing the polygonal model by iterating through all of the polygons in the model sequentially, for example, as follows:

List<Polygon> polyList;
Vector min = positiveInfinity;
Vector max = negativeInfinity;
foreach(Polygon p in polyList)
{

foreach(Vertex v in p)
{

min.x = min(v.x, min.x);
min.y = min(v.y, min.y);
min.z = min(v.z, min.z);
max.x = max(v.x, max.x);
max.y = max(v.y, max.y);
max.z = max(v.z, max.z);

}

}
// Based upon upper limits of possible grid sizes, and size characteristics
of the triangles in the mesh,
// an optimal grid spacing is chosen.
DetermineOptimalGridStep(min, max);

The process then sorts the polygons of the polygonal model into a three dimensional grid at step 354. For example, all of the polygons in the polygonal model can be sorted into respective sub-grids, providing a tool for quickly searching though all nearby or neighboring polygons as provided below (and this can be carried out by inputting the polygonal mesh 1 into a connected set determination module 2 as seen in FIG. 4).

List< Polygon > sortedGrid[ X_GRID_SIZE ][ Y_GRID_SIZE ][
Z_GRID_SIZE ];
foreach(Polygon p in polyList)
{

sortedGrid

[ FindXIndexByXLocation(p) ][ FindYIndexByYLocation(p) ][

FindZIndexByZLocation(p) ].add(p);
}

The process and system may include connected set determination module 2 that determines a neighborhood of potentially connected polygons at step 356 and sorts the polygons based on their respective connected sets at step 358. For example, the process can iterate spatially through the grid, selecting polygons in sequence and comparing them to all potentially connected polygons as determined by the local grid neighborhood. When all the potential neighbors for all the current set members have been exhausted as candidates, the next set is processed. When the final triangle is classified during the iteration process, the classification is complete and the polygonal model is fully sorted and ready for one or more decimation routines 3, removal of the N smallest sets via small set removal 4, or other topology related processing steps 5 at 360. For example:

```
// Loop until the last possible candidate is found and ProcessNextSet( ) returns
NoMoreToProcess
function DetermineSets( )
{
  while( ProcessNextSet( ) == MoreToProcess );
}
function ProcessNextSet( )
{
  Polygon currentPoly = FindUnclassifiedPolygon( );
  if( currentPoly == null )
```

return NoMoreToProcess;

do {

FindConnectedPolygonsInLocalGridNeighborhood( );
currentPoly = FindLowestGridIndexPolygonInSetWithUnfoundNeighbors( );

```
  } while( currentPoly != null );
  return MoreToProcess;
}
function FindConnectedPolygonsInLocalGridNeighborhood( )
{
  for(int z = currentPolyZ−1; z <= currentPolyZ+1; z++)
  {
```

```
for(int y = currentPolyY−1; y <= currentPolyY+1; y++)
{
  for(int x = currentPolyX−1; z <= currentPolyX+1; x++)
  {
```

```
foreach( Polygon p in sortedGrid[x][y][z] )
{
  if( AreConnected( p, currentPoly ) )
  {
```

setLists[ currentSet ].add( p );
UpdateLowestGridIndexPolygonInSetWithUnfoundNeighbors( );

}
}

}
}

}
}

The above described process and associated apparatus is exemplary and can be carried out with fewer or additional steps. Further, certain steps may be carried out in parallel or series.

FIG. 5 illustrates an exemplary computing system 500 configured to perform any one of the above-described processes and may include any of the described modules or systems of the apparatus, which may represent a client device, server, gateway, router, data application service, and so on. In this context, computing system 500 may include, for example, a processor, memory, storage, and input/output devices (e.g., monitor, keyboard, disk drive, Internet connection, etc.). However, computing system 500 may include circuitry or other specialized hardware for carrying out some or all aspects of the processes. In some operational settings, computing system 300 may be configured as a system that includes one or more units, each of which is configured to carry out some aspects of the processes either in software, hardware, firmware, or some combination thereof.

The exemplary computing system 500 includes a number of components that may be used to perform the above-described processes. The main system 302 includes a motherboard 304 having an input/output (“I/O”) section 306, one or more central processing units (“CPU”) 308, and a memory section 310, which may have a flash memory card 312 related to it. The I/O section 306 is connected to a display 324, a keyboard 314, a disk storage unit 316, and a media drive unit 318. The media drive unit 318 can read/write a computer-readable medium 320, which can contain programs 322 and/or data.

At least some values based on the results of the above-described processes can be saved for subsequent use. Additionally, a non-transitory computer-readable medium can be used to store (e.g., tangibly embody) one or more computer programs for performing any one of the above-described processes by means of a computer. The computer program may be written, for example, in a general-purpose programming language (e.g., Pascal, C, C++, Java) or some specialized application-specific language.

Various exemplary embodiments are described herein. Reference is made to these examples in a non-limiting sense. They are provided to illustrate more broadly applicable aspects of the disclosed technology. Various changes may be made and equivalents may be substituted without departing from the true spirit and scope of the various embodiments. In addition, many modifications may be made to adapt a particular situation, material, composition of matter, process, process act(s) or step(s) to the objective(s), spirit or scope of the various embodiments. Further, as will be appreciated by those with skill in the art, each of the individual variations described and illustrated herein has discrete components and features that may be readily separated from or combined with the features of any of the other several embodiments without departing from the scope or spirit of the various embodiments. All such modifications are intended to be within the scope of claims associated with this disclosure.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

1. A computer enabled method of classifying connected sets in a polygon object, comprising the acts of:
providing a polygonal model with spatially grid-like topology;
sorting polygons in the model into a three dimensional grid; and
determining a neighborhood of potentially connected polygons based on a topological consistency of the polygonal model; and
sorting each polygon into one of a plurality of connected sets.

2. The method of claim 1, further comprising rendering the polygonal model based on less than all of the plurality of connected sets.

3. The method of claim 1, wherein a user provides a polygonal model where each polygon has a consistent maximal width, height, and depth.

4. The method of claim 1, wherein the bounds of the polygonal model are determined by examining the XYZ components of each vertex in the model and storing the minimum and maximum bounds for each component.

5. The method of claim 1, wherein each polygon in the model is sorted into a list containing the polygons in the specified sub-grid of the polygonal model topology.

6. The method of claim 1, wherein the sorted polygons are iterated through, using information about potential neighbors to any given polygon, determining polygons that are connected spatially, defined as two XYZ points in one polygon having the same correspondent XYZ values.

7. The method of claim 6, wherein in response to determining polygons are connected spatially, storing the polygons into a list representing that connected set, and storing a reference between two connected polygon edges.

8. A computer readable storage medium storing computer code to carry out the method of claim 1.

9. An electronic device, comprising:
one or more processors;
memory; and
one or more programs, wherein the one or more programs are stored in the memory and configured to be executed by the one or more processors, the one or more programs including instructions for:
receiving a polygonal model with spatially grid-like topology;
sorting polygons in the model into a three dimensional grid; and
determining a neighborhood of potentially connected polygons based on a topological consistency of the polygonal model; and
sorting each polygon into one of a plurality of connected sets.

10. The electronic device of claim 9, further comprising causing a display of a polygon model based on less than all of the plurality of connected sets.

11. Apparatus for representing a three dimensional object, comprising:
a first computer readable storage that stores a polygonal data-set representing a surface model in 3 dimensions, wherein the data-set includes a plurality of elements; providing a plurality of points for each element, wherein the points represent the corners connecting the primary edges of the polygon element;
a second computer readable storage which stores a list of references to polygonal elements for a given sub-grid in the three dimensional space; and
a third computer readable storage which stores a list of lists, wherein each outer list represents a connected set of polygons, and each inner list contains a list of references to polygons in that connected set, and each polygon reference includes a list of references to the immediate connected polygons to that polygon.

12. The apparatus of claim 11, wherein the user provides a polygonal model where each polygon has a consistent maximal width, height, and depth.

13. The apparatus of claim 11, wherein the bounds of the polygonal model are determined by examining the XYZ components of each vertex in the model and storing the minimum and maximum bounds for each component.

14. The apparatus of claim 11, wherein each polygon in the model is sorted into a list that includes all the polygons in the specified sub-grid of the polygonal model topology.

15. The apparatus of claim 11, wherein the sorted polygons are iterated through, using information about potential neighbors to each polygon, to determine all polygons that are connected spatially, defined as two XYZ points in one polygon having precisely the same correspondent XYZ values.

16. The apparatus of claim 15, wherein in response to determining polygons are connected spatially, storing the polygons into a list representing that connected set, and storing a reference between two connected polygon edges.
